(19) United States
(12) Patent Application Publication
(10) Pub. No.: US 2025/0013068 A1
(43) Pub. Date: Jan. 9, 2025

(54) OPTICAL HOMOGENIZER AND DE-SPECKLE DEVICE INCLUDING SAME

(71) Applicant: Young Optics Inc., Hsinchu City (TW)

(72) Inventors: Yu Chen CHANG, Hsinchu City (TW); Tsung-Ta LEE, Hsinchu City (TW)

(73) Assignee: Young Optics Inc., Hsinchu City (TW)

(21) Appl. No.: 18/529,020

(22) Filed: Dec. 5, 2023

(30) Foreign Application Priority Data
Jul. 6, 2023 (TW) 112125314

(51) Int. Cl. G02B 27/48; G02B 26/08; G02B 27/09

(52) U.S. Cl. CPC G02B 27/48; G02B 26/0875; G02B 27/0955

(57) ABSTRACT

A de-speckle device includes an optical homogenizer, a connecting mechanism, and an actuator. The optical homogenizer includes a diffuse surface and a reflecting surface disposed opposite to the diffuse surface. One end of the connecting mechanism is connected to the optical homogenizer. The actuator can move the optical homogenizer back and forth along an axis of the optical homogenizer.

### RELATED APPLICATION

This application claims the benefit of priority of Taiwan Patent Application No. 112125314 filed on Jul. 6, 2023, the contents of which are incorporated by reference as if fully set forth herein in their entirety.

### FIELD

The present disclosure relates to display technologies, and more particularly, to an optical homogenizer and a de-speckle device including the same.

### BACKGROUND

In a structure of a lighting and light combining system of a laser projector, light spots appear on a screen due to speckle effect of a laser light source. A conventional technology uses a diffuser in the lighting and light combining system. In order to achieve a better speckle elimination effect, a conventional technology makes the diffuser vibrate or rotate to achieve effect of eliminating speckles.

A conventional technology uses a wheel-shaped diffuser (diffuser wheel), and a motor rotates the wheel-shaped diffuser to achieve the effect of eliminating speckles. But this structure is bulky, and the motor has a lot of noise.

Chinese Patent No. CN112764297A discloses a dynamic diffuser assembly, which includes an upper moving part, a lower fixed part, four elastic supports, and four sets of magnet coils. The mechanism is complex and difficult to locate the upper moving part. It is not easy to adjust the vibration path and direction of the moving part. US Patent No. U.S. Pat. No. 20,160,306,183 discloses an optical element for reducing speckle noise and discloses three or four elastic components with complex structures and three or four sets of magnet coils. Chinese Patent No. CN113641061B discloses a light beam speckle elimination device, which includes four pieces of elastic sheets with a relatively complex structure and two sets of magnet coils. It still does not solve the problems of difficult positioning and difficult adjustment of the vibration path and direction of moving part.

Chinese patent No. CN215264354U discloses a speckle eliminating device, including eight springs and four sets of magnet coil groups. In order to solve a problem that horizontal springs are difficult to maintain in a vertical direction, an arc-shaped protrusion is also provided below a mounting base to avoid positioning deviations in the vertical direction. Taiwan Patent No. TWI326793 discloses an integral column adjustment device, which uses screws to adjust the integral column. Taiwan Patent No. TWI308250 discloses an integral column and the optical engine, and also uses screws to adjust the integral column.

### SUMMARY

In view of the above, the present disclosure provides an optical homogenizer and a de-speckle device including the same to effectively solve the problems of complex structure, difficult positioning, and difficulty in adjusting the vibration path and direction of moving parts in the prior art.

In order to achieve above-mentioned object of the present disclosure, one embodiment of the disclosure provides a de-speckle device, including: an optical homogenizer, a connecting mechanism, and an actuator. The optical homogenizer includes a diffuse surface and a reflecting surface disposed opposite to the diffuse surface. One end of the connecting mechanism is connected to the optical homogenizer. The actuator is configured to move the optical homogenizer back and forth along an axis of the optical homogenizer.

Another embodiment of the disclosure further provides an optical homogenizer, including: an elongate structure, a diffuse surface, and a reflecting surface. The elongate structure includes a light incident end and a light outgoing end. The diffuse surface is facing an inner side of the elongated structure. The reflecting surface is facing the inner side of the elongated structure and disposed opposite to the diffuse surface. The optical homogenizer is configured to make a light beam entering through the light incident end exit from the light outgoing end.

In comparison with prior art, the disclosure de-speckle device moves the optical homogenizer back and forth along an axis of the optical homogenizer by the actuator to simplify the structure, to facilitate assembly and positioning, and to adjust a vibration path and a direction of a moving part, such that the problems in prior art can effectively avoid.

### BRIEF DESCRIPTION OF DRAWINGS

FIG. 1A is a schematic plan view of a structure of an optical homogenizer of one embodiment of the disclosure.

FIG. 1B is a schematic view of a cross-sectional structure along AA′ line in FIG. 1A.

FIG. 2 is a schematic view of a light beam passing through an optical homogenizer and a vibration direction of the uniform element according to an embodiment of the present disclosure.

FIG. 3A shows a schematic plan view of an optical homogenizer according to another embodiment of the present disclosure;

FIG. 3B shows a schematic view of a cross-sectional structure along BB′ line in FIG. 3A;

FIG. 4A shows a schematic plan view of an optical homogenizer according to still another embodiment of the present disclosure;

FIG. 4B shows a schematic view of a cross-sectional structure along CC′ line in FIG. 4A;

FIG. 5 shows a schematic view of a structure of a de-speckle device according to an embodiment of the present disclosure;

FIG. 6A shows a schematic view of a cross-sectional structure of the de-speckle device according to FIG. 5;

FIG. 6B shows a schematic view of a vibration direction of the de-speckle device according to FIG. 5;

FIG. 7 shows a schematic structural view of another viewing angle of the de-speckle device according to FIG. 5;

FIG. 8 shows a schematic structural view of a de-speckle device according to another embodiment of the present disclosure;

FIG. 9 shows a schematic view of a cross-sectional structure of the de-speckle device according to FIG. 8;

FIG. 10 shows a schematic structural view of a de-speckle device according to still another embodiment of the present disclosure;

FIG. 11 shows a schematic view of a cross-sectional structure of the de-speckle device according to FIG. 10;

FIG. 12 shows a schematic structural view of a de-speckle device according to yet another embodiment of the present disclosure;

FIG. 13 shows a schematic structural view of a de-speckle device according to another embodiment of the present disclosure; and

FIG. 14 shows a schematic structural view of another viewing angle of the de-speckle device according to FIG. 13.

### REFERENCE NUMERALS DESCRIPTION

10, 10′, 10″, 10′″, 10a, and 10b: optical homogenizer; 100, 100′, 100″, 100′″, and 200: de-speckle device; 20 and 20′: connecting mechanism; 32: magnets; 36: motor; 40 and 40′: outer frame; AA′, BB′, and CC′: cross-section line; RS: reflecting surface; LS, LS′, and LS″: elongate structure; OA: optical axis; 30, 30′, 30″, and 30′″: actuators; 34: coil; 38: cam; 50: bearing seat; DS: diffuse surface; IE: light incident end; LB: light beam; and OE: light outgoing end.

### DETAILED DESCRIPTION

In order to make the above and other objects, features, and advantages of the present disclosure more obvious and understandable, preferred embodiments of the present disclosure will be cited below, together with the drawings, for a detailed description as follows. Furthermore, the direction terms mentioned in this disclosure, such as up, down, top, bottom, front, back, left, right, inside, outside, side layer, surrounding, center, horizontal, transverse, vertical, longitudinal, axial, radial direction, the uppermost layer, or the lowermost layer, etc., are only directions for referring to the attached drawings. Therefore, the directional terms are used to explain and understand the present disclosure, but not to limit the present disclosure. In the figures, structurally similar units are denoted by the same reference numerals.

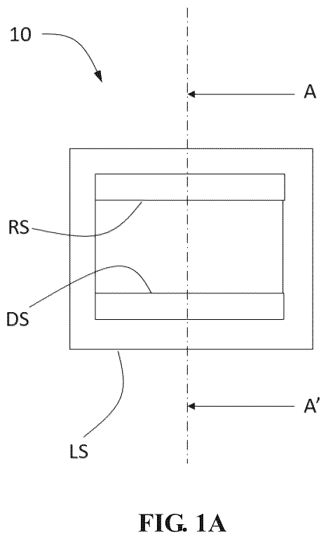

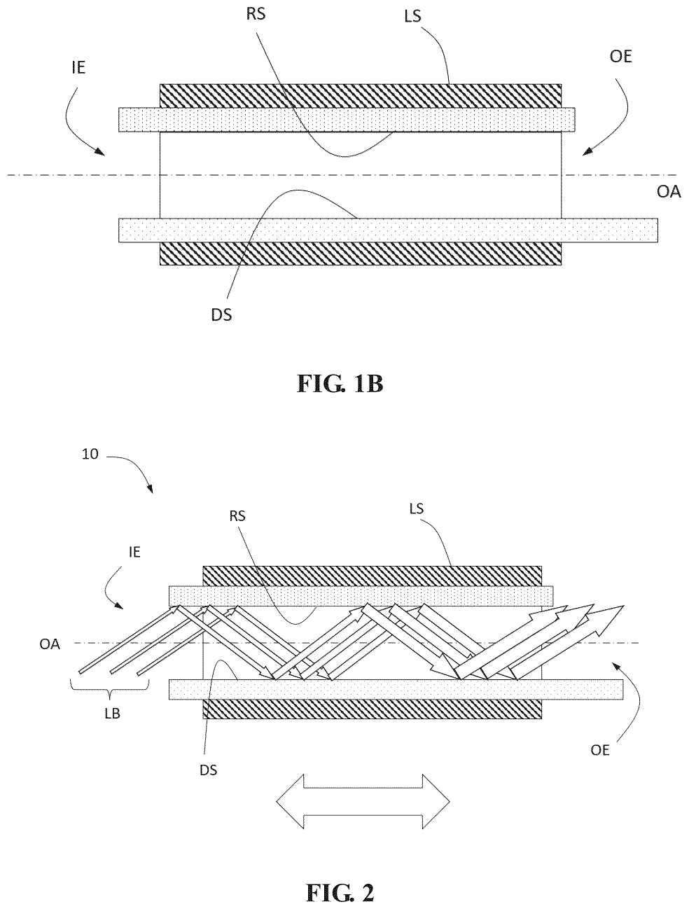

FIG. 1A shows a schematic plan view of an optical homogenizer according to an embodiment of the present disclosure. FIG. 1B shows a schematic cross-sectional structure along AA′ line in FIG. 1A. FIG. 2 shows a schematic diagram of a light beam passing through the optical homogenizer according to an embodiment of the disclosure. Referring to FIG. 1A to FIG. 2, the present disclosure provides an optical homogenizer 10, including an elongate structure LS, a diffuse surface DS, and a reflecting surface RS. The elongate structure LS includes a light incident end IE and a light outgoing end OE. The diffuse surface DS faces the inner side of the elongate structure LS. The reflecting surface RS is opposite to the diffuse surface DS and faces to the inner side of the elongate structure LS. The optical homogenizer 10 enables the light beam LB entering through the light incident end IE to exit from the light outgoing end OE.

In detail, referring to FIG. 2, if an incident light beam LB is laser light, by multiple reflections of the light beam LB between the diffuse surface DS and the reflecting surface RS, by a beam expansion effect of the diffuse surface DS on the light beam LB, and by the optical homogenizer 10 vibrating back and forth in a direction parallel to an optical axis OA, the light beam LB can achieve an effect of eliminating speckle of a laser beam in space, an effect of expanding the laser beam while reducing the optical path difference, and an effect of uniform light. In detail, a rough surface structure of the diffuse surface DS itself can increase randomness of spatial distribution of the laser beam, thereby destroying coherence of the laser. In addition, by vibrating the diffuse surface back and forth, the randomness of the spatial distribution can be increased in time dimension, and the coherence of the laser beam can be further destroyed to achieve a better de-speckle effect. The optical axis OA is defined as an axis extending between the light incident end IE and the light outgoing end OE of the optical homogenizer 10. An axial direction of the optical homogenizer 10 is parallel to the optical axis OA.

In detail, the light beam LB traveling along the optical axis OA will form a light cone after passing through some optical elements such as lenses and is incident the elongate structure LS at a predetermined angle. In one embodiment of the present disclosure, the light beam LB is at least reflected on the diffuse surface DS twice and on the reflecting surface RS twice before exiting from the light outgoing end OE.

In detail, the elongate structure LS is used to provide a reflecting surface and/or a diffuse surface so as to pass the light beam LB entering the elongate structure LS along the optical axis OA. Shape of opening of the elongate structure LS depends on desired beam shape. In the embodiment disclosed in FIG. 1A, the elongate structure LS has a hollow structure and a rectangular opening of the light incident end IE. The hollow structure of the elongate structure LS is used for disposing the reflecting surface and/or the diffuse surface. At least one diffuse surface and one reflecting surface are provided in the elongate structure LS, and the other two surfaces can be provided with reflecting surfaces or diffuse surfaces as required.

In detail, the reflecting surface RS is used to reflect the light beam LB entering the elongate structure LS. In one embodiment of the present disclosure, the reflecting surface RS is a mirror surface.

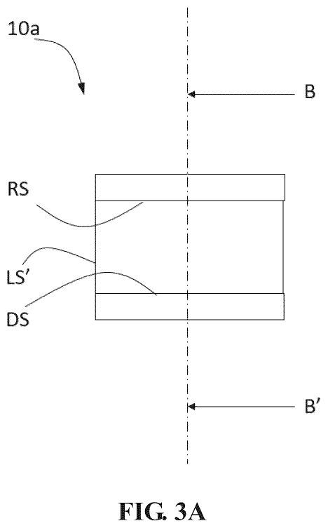

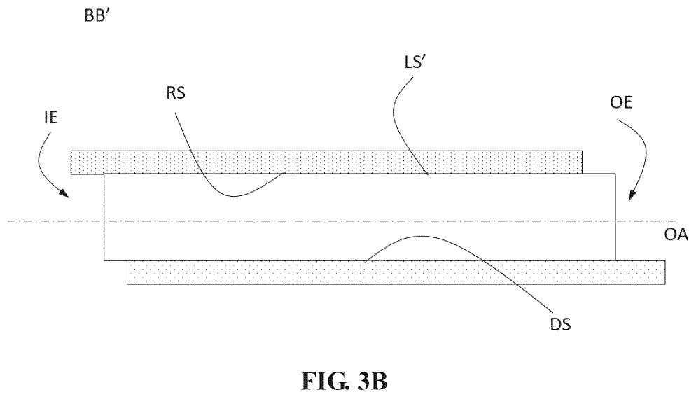

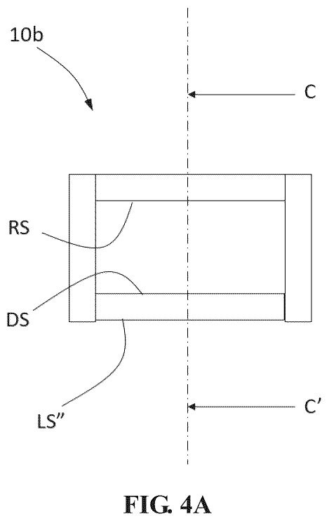

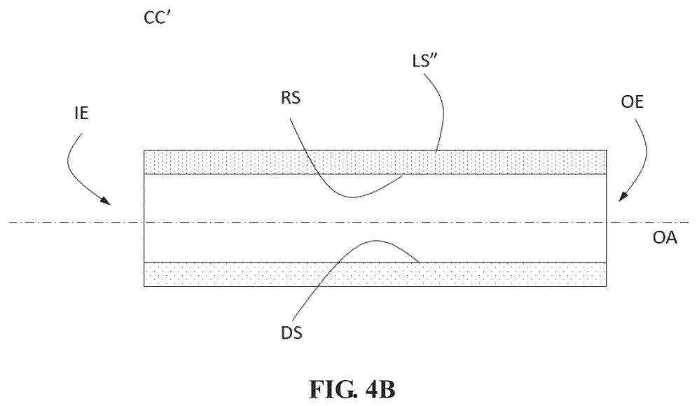

In detail, the diffuse surface DS is used to diffuse the light beam LB entering the elongate structure LS to achieve preliminary effects of speckle elimination, beam expansion, and uniform light effects. The diffuse surface DS is, for example, a micro-lens array, a light diffusing element, or a reflective element with microstructures on surface. The elongate structure LS is, for example, an elongated hollow frame. In another preferred embodiment, the diffuse surface DS and the reflecting surface RS may be of equal or unequal length, aligned or staggered. In detail, FIG. 1B shows an embodiment in which the lengths of the diffuse surface DS and the reflecting surface RS are not equal. FIG. 4B shows an embodiment in which the diffuse surface DS and the reflecting surface RS are aligned and arranged with the same length. FIG. 3B shows an embodiment in which the diffuse surfaces DS and the reflecting surfaces RS are of equal length and arranged in a staggered manner.

In detail, in another embodiment, the optical homogenizer 10 includes four surfaces, at least one surface is provided with a diffuse surface, and one surface is provided with a reflecting surface. The other two surfaces can be provided with reflecting surfaces or diffuse surfaces as required.

In one embodiment of the present disclosure, the optical homogenizer is an integral rod.

Referring to FIGS. 3A and 3B, in one embodiment of the present disclosure, the integral column is solid. In detail, different from the elongate structure LS having a hollow structure in FIG. 1A, the elongate structure LS' of the optical homogenizer 10a in FIG. 3A is a solid transparent body, such as glass, quartz, or sapphire.

In detail, the elongate structure LS' is used to dispose a reflecting surface and/or a diffuse surface so as to allow the light beam entering the elongate structure LS' along the optical axis OA to pass through. A cross-sectional shape of the light incident end IE of the elongate structure LS' depends on a shape of incident light beam, and a cross-sectional shape of the light outgoing end OE depends on desired shape of outgoing light beam. In the embodiment disclosed in FIG. 3A, the elongate structure LS' has a solid structure and a light incident end IE with rectangular cross-section. The surface of the solid structure of the elongate structure LS' is used for disposing the reflecting surface and/or the diffuse surface. The solid transparent body of the elongate structure LS' is used for light beams to pass through. At least one diffuse surface and one reflecting surface are provided on surfaces of the elongate structure LS′, and the other two surfaces can be provided with reflecting surfaces or diffuse surfaces as required.

In detail, the reflecting surface RS is used to reflect beam entering the elongate structure LS′. In one embodiment of the present disclosure, the diffuse surface DS is disposed outside the elongate structure LS′. In one embodiment of the present disclosure, the reflecting surface RS is a mirror surface.

In detail, the diffuse surface DS is used to diffuse the light beam entering the elongate structure LS' to achieve preliminary effects of speckle elimination, beam expansion, and uniform light effects. In one embodiment of the present disclosure, the reflecting surface RS is disposed outside the elongate structure LS′. The diffuse surface DS is, for example, a micro-lens array, a light diffusing element, or a reflective element with microstructures on surface. In another preferred embodiment, the diffuse surface DS and the reflecting surface RS may be of equal or unequal length, aligned or staggered. In detail, FIG. 1B shows an embodiment in which the lengths of the diffuse surface DS and the reflecting surface RS are not equal. FIG. 4B shows an embodiment in which the diffuse surface DS and the reflecting surface RS are aligned and arranged with the same length. FIG. 3B shows an embodiment in which the diffuse surfaces DS and the reflecting surfaces RS are of equal length and arranged in a staggered manner.

In one of the embodiments of the present disclosure, A microstructure is formed on surfaces of a substrate by nanoimprinting, wafer-level lens or metalens on the diffuse surface of the optical homogenizer.

In detail, in another embodiment, the optical homogenizer 10a includes four surfaces, at least one of which is provided with a diffuse surface, one is provided with a reflecting surface, and the other two surfaces can be provided with a reflecting surface or a diffuse surface as required.

Referring to FIGS. 4A and 4B, it is different from the elongate structure LS in FIG. 1A or the elongate structure LS' in FIG. 3A. In detail, in an embodiment, a structure LS″, for example, consists of four elongate sheets, such as four glass sheets, four quartz sheets, or four sapphire sheets, at least one of which has a diffuse surface DS, and at least one of which has a reflecting surface RS.

In detail, the elongate structure LS″ is provided with a reflecting surface and/or a diffuse surface so as to allow the light beam entering the elongate structure LS″ along the optical axis OA to pass through. determines A cross-sectional shape of the light incident end IE of the elongate structure LS″ depends on the shape of the incident light beam, and a cross-sectional shape of the light outgoing end OE depends on desired shape of the outgoing light beam. In the embodiment disclosed in FIG. 4A, the elongate structure LS″ has a hollow structure composed of four sheets and a rectangular cross-section of the light incident end IE. At least one surface of the inner surface of the four sheets of the elongate structure LS″ is provided with a diffuse surface, one surface is provided with a reflecting surface, and the other two surfaces can be provided with reflecting surfaces and/or diffuse surfaces. The hollow structure of the elongate structure LS″ is used for light beams to pass through. In a preferred embodiment, the inner surfaces of the elongate structure LS″ includes at least one diffuse surface and one reflecting surface, and the other two surfaces can be reflecting surface or diffuse surface as required.

In detail, the reflecting surface RS is used to reflect the light beam entering the elongate structure LS″. In one embodiment of the present disclosure, the diffuse surface DS is disposed on the inner surface of the elongate structure LS″. In one embodiment of the present disclosure, the reflecting surface RS is a mirror surface.

In detail, the diffuse surface DS is used to diffuse the light beam entering the elongate structure LS″ to achieve preliminary speckle elimination, beam expansion, and uniform light effects. In one of the embodiments of the present disclosure, the reflecting surface RS is located on the inner surface of the elongate structure LS″. The diffuse surface DS is, for example, a micro-lens array, a light diffusing element, or a reflecting element with microstructures on surface. In another preferred embodiment, the diffuse surface DS and the reflecting surface RS may have equal or unequal lengths and may be aligned or staggered. In detail, FIG. 1B shows an embodiment in which the lengths of the diffuse surface DS and the reflecting surface RS are not equal. FIG. 4B shows an embodiment in which the diffuse surface DS and the reflecting surface RS are aligned and arranged with the same length. FIG. 3B shows an embodiment in which the diffuse surfaces DS and the reflecting surfaces RS are of equal length and arranged in a staggered manner.

In detail, in another embodiment, the optical homogenizer 10a includes four surfaces, at least one surface is provided with a diffuse surface, one surface is provided with a reflecting surface, and the other two surfaces can be provided with reflecting surfaces or diffuse surfaces as required.

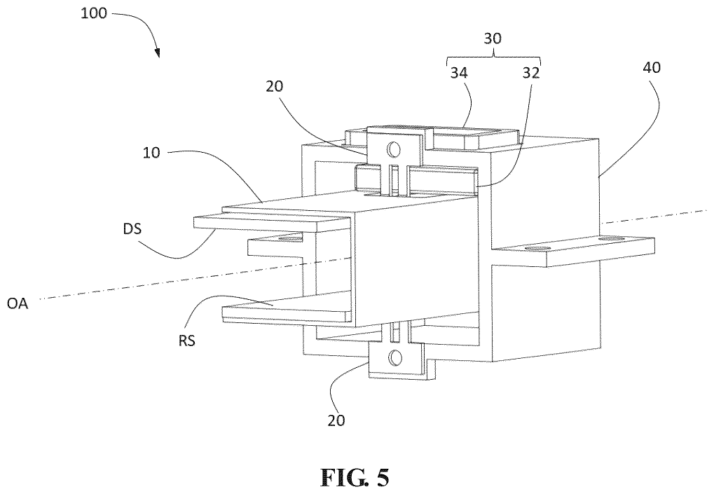

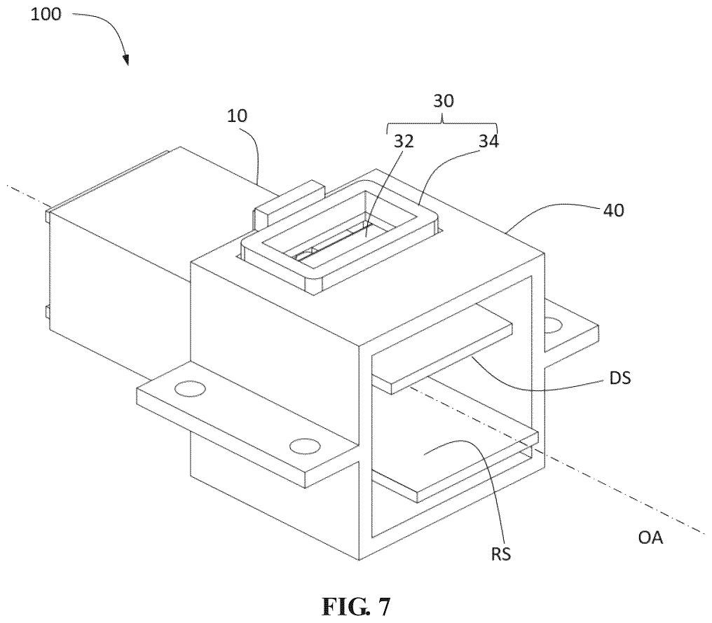

Referring to FIG. 5 to FIG. 7, a de-speckle device 100, which including an optical homogenizer 10, a connecting mechanism 20 and an actuator 30, of the present disclosure is disclosed. The optical homogenizer 10 includes a diffuse surface DS and a reflecting surface RS. One end of the connecting mechanism 20 is connected to the optical homogenizer 10. The actuator 30 can move the optical homogenizer 10 back and forth along an axis of the optical homogenizer 10 (such as the direction parallel to the optical axis OA in the figure).

The optical homogenizer 10 is as described above and will not be repeated here.

In detail, the connecting mechanism 20 is used to connect the optical homogenizer 10 and a fixed point, such as an outer frame, so as to provide resilience for the optical homogenizer 10 to vibrate back and forth. In detail, one end of the connecting mechanism 20 is connected to the optical homogenizer 10 means that the connecting mechanism 20 is directly or indirectly connected to the optical homogenizer 10. Indirect means, for example, that the optical homogenizer 10 is disposed on a bearing seat.

In detail, the actuator 30 is used to push the optical homogenizer 10 to reciprocate or vibrate along its optical axis OA direction, cooperated with the connecting mechanism 20. In detail, reciprocating vibration along the optical axis OA is a movement with one degree of freedom, but the present disclosure is not limited thereto. In another embodiment, the de-speckle device can also be provided with two or more set of actuators and connecting mechanisms to provide two or more degrees of freedom of movement, such as moving back and forth perpendicular to the axis of the optical homogenizer (for example, perpendicular to the direction of the optical axis OA in the figure).

In detail, the optical homogenizer 10 with the diffuse surface DS has an effect of diffusing the light beam entering the elongate structure to achieve preliminary speckle elimination, beam expansion, and light uniformity. By cooperating with the actuator 30 to push the optical homogenizer 10 to reciprocate or vibrate along the direction of its optical axis OA, the effect of speckle elimination can be enhanced.

In detail, depending on the type, size, and severity of the speckle, the vibration frequency of the actuator 30 disclosed in the present disclosure is preferably greater than 0 Hz and less than 400 Hz, or a higher vibration frequency. The vibration displacement of the optical homogenizer 10 is preferably greater than 0 mm and less than 5 mm, or higher, to effectively eliminate speckle.

In one embodiment, the optical homogenizer 10 of the de-speckle device 100 includes at least one reflecting surface RS or at least one diffuse surface DS. In detail, in another preferred embodiment, the optical homogenizer 10 may include more than 2, 3, or 4 surfaces, depending on requirements. These surfaces can be selected from reflecting or diffuse surfaces and be combined according to actual needs.

In one embodiment of the present disclosure, the connecting mechanism 20 is an elastic element.

In one embodiment of the present disclosure, the elastic element is a plate spring.

In detail, in one of the embodiments of the present disclosure, the plate spring is integrated with the elongate structure of the optical homogenizer 10.

In one embodiment of the present disclosure, the diffuse surface of the optical homogenizer 10 has a microstructure. In detail, the microstructure is, for example, a metalens structure. It is a sub-wavelength columnar array microstructure, and the surface of the metalens with columnar structures (also known as nano-fins, waveguides, or antennas) with a specific array distribution can be used to flexibly and greatly adjust optical properties of incident light, such as phase, amplitude, and polarization. The diffuse surface of the optical homogenizer 10 having a metalens structure can have an excellent effect of eliminating speckle, and there is no need to vibrate the optical homogenizer 10. The metalens structure is generally a nano-element made of titanium dioxide material, and the size of the element is in the sub-wavelength range of about 600 nanometers. It can be fabricated by nanoimprint, wafer-level lens, and other methods. Wafer-level lenses refer to the production of optical elements or microstructures using semiconductor manufacturing processes on wafer.

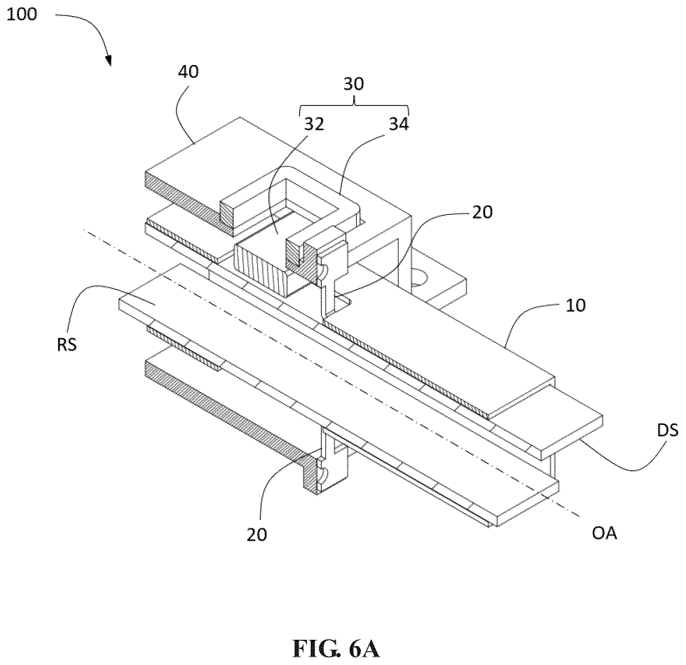

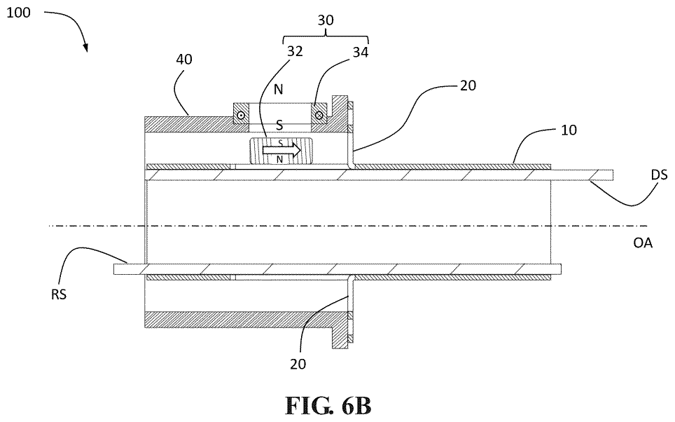

Referring to FIGS. 6A and 6B, in one embodiment of the present disclosure, the actuator 30 includes a magnet 32 and a coil 34 and drives the optical homogenizer 10 to move through electromagnetic force at a distance. Referring to FIG. 6B, in detail, when the coil 34 is energized, the induction generates a magnetic field with the N pole on the top and the S pole on the bottom, so that the N pole of the magnet 32 is attracted and moves to the right (as shown by the arrow in FIG. 6B) to drive the optical homogenizer 10 to move to the right. At this time, the connecting mechanism 20 is deformed to accumulate elastic potential energy. When the coil 34 is de-energized, the induced magnetic field disappears, so that the connecting mechanism 20 releases the elastic potential energy to make the optical homogenizer rebound to the left, and reciprocating movement is performed in this way. The reciprocating movement, or vibration, is one degree of freedom movement, but the present disclosure is not limited thereto. In another embodiment, the de-speckle device can also be provided with a second set or more of actuators and connecting mechanisms to provide movement in a second direction of a second degree of freedom, for example a back-and-forth movement perpendicular to the axis of the optical homogenizer.

In another embodiment of the present disclosure, the connecting mechanism 20 is used to provide a flexible connection function. A flexible connection is relative to a rigid connection. In a rigid connection, there is no displacement between opposing connected members. A flexible connection allows displacement between the connected parts, such as a pivot joint or a connection using elastic material. In a preferred embodiment, in addition to moving the optical homogenizer 10 back and forth along an axis of the optical homogenizer (such as the direction parallel to the optical axis OA in the figure), the connecting mechanism 20 is also used to keep the optical axis OA of the optical homogenizer 10 in the same direction. In another embodiment of the present disclosure, the connecting mechanism 20 only provides the connecting function, but does not provide elastic restoring force. The actuator 30 includes a magnet 32 and a coil 34 and drives the optical homogenizer 10 to move through an electromagnetic force at a distance. Referring to FIG. 6B, in detail, when the coil 34 is energized, the induction generates a magnetic field with the N pole on the top and the S pole on the bottom, so that the N pole of the magnet 32 is attracted and moves to the right (as shown by the arrow in FIG. 6B) to drive the optical homogenizer 10 to move to the right. Then a current direction on the coil 34 is reversed, and the induction produces a reverse magnetic field, that is, a magnetic field with the N pole at the bottom and the S pole at the top, so that the N pole of the magnet 32 is repelled and moves to the left (the opposite direction as shown by the arrow in FIG. 6B) to drive the optical homogenizer 10 to move to the left, and to perform reciprocating movement in this way.

The de-speckle device in one of the embodiments of the present disclosure further includes an outer frame 40, wherein one of the magnet 32 and the coil 34 is arranged at the uniform light element 10, and the other is arranged at the outer frame 40 corresponding to each other.

In detail, one end of the connecting mechanism 20 is fixed to the outer frame 40, and another end is fixed to the optical homogenizer 10, wherein the outer frame 40 is a fixed part, and the optical homogenizer 10 is a movable part. The connecting mechanism 20 can be used to position the optical homogenizer 10 in the outer frame 40. In one of the embodiments of the present disclosure, the connecting mechanism 20 is a plate spring, and the plate spring can be a π-shaped plate structure, which can limit the movement of the optical homogenizer 10 in a direction parallel to the optical axis OA other from easy to move in other directions and affect the optical effect. The plate spring can also provide an elastic restoring force between the fixed part and the moving part, so that the optical homogenizer 10 can vibrate back and forth under the push of the actuator 30.

In one embodiment of the present disclosure, the actuator 30 is provided with a first part and a second part correspondingly interchangeable, such as a magnet and a coil. The magnet and the coil are a set of actuators, which can drive the optical homogenizer 10 to move through the electromagnetic force at a distance. Similarly, the magnets and coils are, for example, voice coil motors. The voice coil motor is used to make the diffuser vibrate at a small angle through a plate spring. The structure is simple, and the volume is smaller than the conventional motor-rotating wheel diffuser structure.

In one embodiment of the present disclosure, the actuator 30 is provided with a corresponding first part and a second part, which are interchangeable magnetic conductive element and electromagnet. The magnetic conductive element and the electromagnet are a set of actuators, which can drive the optical homogenizer 10 to move through electromagnetic force at a distance.

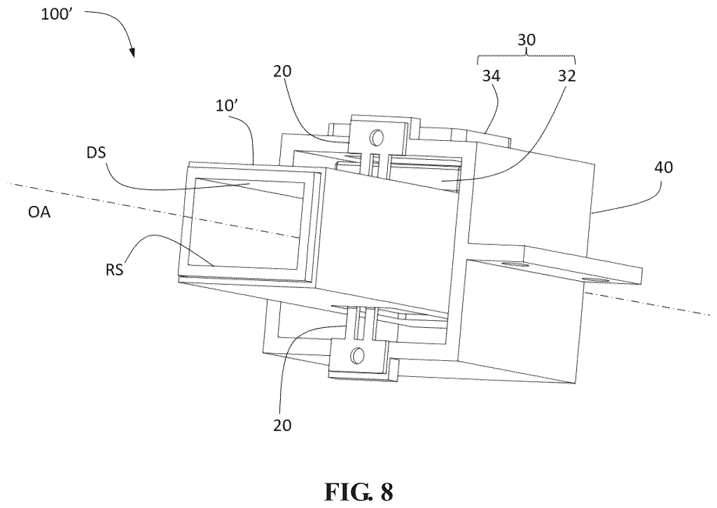

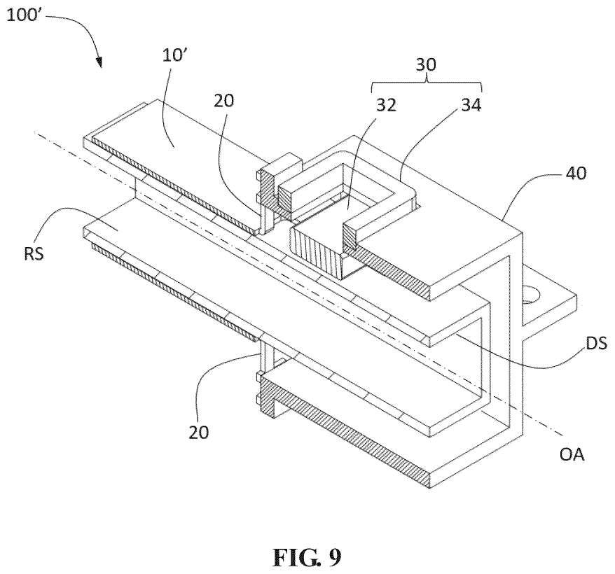

Referring to FIG. 8 and FIG. 9, in another embodiment of the present disclosure, different from the de-speckle device 100 in FIG. 5 to FIG. 7, the optical homogenizer 10′ includes four surfaces including a reflecting surface RS and a diffuse surface DS, while the uniform light element 10 of the de-speckle device 100 only includes the reflecting surface RS and the diffuse surface DS. Moreover, the elongate structure LS of the optical homogenizer 10′ of the de-speckle device 100′ of this embodiment does not cover the entire optical homogenizer 10′, so the magnet 32 is directly arranged on the structure of the diffuse surface DS, which can further reduce the volume of the entire de-speckle device 100′.

In detail, the optical homogenizers 10, 10a, and 10b shown in FIGS. 1A to 4B can be replaced with the optical homogenizers of de-speckle devices 100, 100′, 100″, 100′″, and 200 of the disclosure according to requirements.

In detail, the connecting mechanism 20 is used to connect the optical homogenizer 10′ to a fixed point, such as an outer frame, to provide resilience for the optical homogenizer 10′ to vibrate back and forth.

In detail, the actuator 30 is used to push the optical homogenizer 10′ to reciprocate and vibrate along the direction of its optical axis OA cooperated with the connecting member 20. In detail, reciprocating vibration along the optical axis OA is a movement with one degree of freedom, but the present disclosure is not limited thereto. In another embodiment, the de-speckle device may also be provided with a second or more sets of actuators and connecting parts to provide two or more degrees of freedom of movement, for example, to move back and forth along a direction perpendicular to the axis of the optical homogenizer.

In detail, the optical homogenizer 10′ provided with the diffuse surface DS has the effect of diffusing the light beam entering the elongate structure to achieve preliminary speckle elimination, beam expansion, and light uniformity effects. By cooperating with the actuator 30 to push the optical homogenizer 10′ to reciprocate and vibrate along the direction of its optical axis OA, the effect of speckle elimination can be enhanced.

In detail, depending on the type, size, and severity of the speckle, the vibration frequency of the disclosed actuator 30 is preferably greater than 0 Hz and less than 400 Hz, or a higher vibration frequency. The vibration displacement of the optical homogenizer 10 is preferably greater than 0 mm and less than 5 mm, or higher, to effectively eliminate speckle.

In one of the embodiments of the present disclosure, the four surfaces of the optical homogenizer 10′ of the de-speckle device 100′ include at least one reflecting surface RS or at least one diffuse surface DS. In detail, these surfaces can be selected from reflecting surfaces or diffuse surfaces and be combined according to actual needs.

In one embodiment of the present disclosure, the connection mechanism 20 is an elastic element.

In one embodiment of the present disclosure, the elastic element is a plate spring.

In detail, in one embodiment of the present disclosure, the plate spring is integrated with the elongate structure of the optical homogenizer 10′.

In one of the embodiments of the present disclosure, microstructures on the substrate surface of the diffuser of the optical homogenizer 10′ is formed by means of nanoimprint, wafer-level lens, or metalens.

The vibration mode of the optical homogenizer 10′ of the de-speckle device 100′ can refer to FIGS. 6A and 6B and will not be repeated here. The reciprocating movement, or vibration, is one degree of freedom movement, but the present disclosure is not limited thereto. In another embodiment, the de-speckle device can also be provided with a second or more sets of actuators and connecting mechanism to provide movement in a second direction of a second degrees of freedom, for example movement back and forth perpendicular to an axis of the optical homogenizer.

The de-speckle device in one of the embodiments of the present disclosure further includes an outer frame 40, one of the magnet 32 and the coil 34 is arranged at the optical homogenizer 10′, and the other is arranged at the outer frame 40 corresponding to each other.

In detail, one end of the connecting mechanism 20 is fixed to the outer frame 40, and another end is fixed to the optical homogenizer 10′, wherein the outer frame 40 is a fixed part, and the optical homogenizer 10′ is a moving part. The connecting mechanism 20 can be used to position the optical homogenizer 10′ in the outer frame 40. In one of the embodiments of the present disclosure, the connecting mechanism 20 is a plate spring, and the plate spring can be a π-shaped plate structure, which can limit the optical homogenizer 10′ move in the direction parallel to the optical axis OA other from easy to move in other directions and affect the optical effect. The plate spring can also provide an elastic restoring force between the fixed part and the moving part, so that the optical homogenizer 10′ can vibrate back and forth under the push of the actuator 30.

In one embodiment of the present disclosure, the actuator 30 is provided with a first part and a second part, which are correspondingly interchangeable, such as a magnet and a coil. The magnet and the coil are a set of actuators, which can drive the optical homogenizer 10′ to move through the electromagnetic force at a distance. Similarly, the magnets and coils are, for example, voice coil motors. The voice coil motor is used to make the diffuser vibrate at a small angle through a plate spring. The structure is simple, and the volume is smaller than the conventional motor-rotating wheel diffuser structure.

In one embodiment of the present disclosure, the actuator 30 is provided with a corresponding first part and a second part, which are interchangeable magnetic conductive element and electromagnet. The magnetic conductive element and the electromagnet are a set of actuators, which can drive the optical homogenizer 10′ to move through the electromagnetic force at a distance.

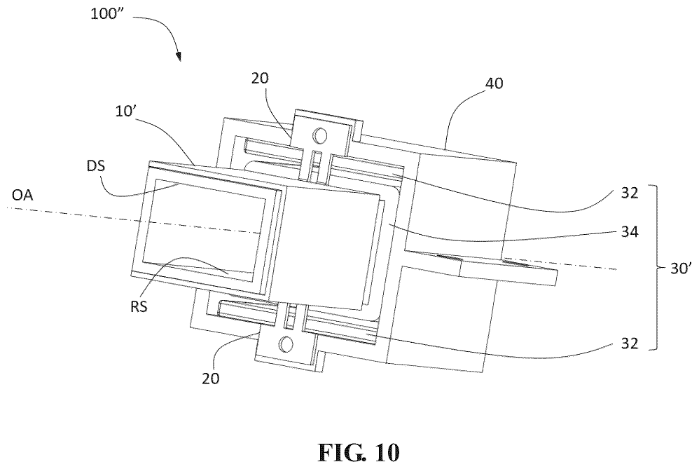

Referring to FIG. 10 and FIG. 11, in another embodiment of the present disclosure, unlike the aforementioned de-speckle device 100′, the actuator 30′ of the de-speckle device 100″ of this embodiment includes two magnets 32 and one coil 34. The coil 34 is wound on the optical homogenizer 10′. The two magnets 32 are arranged at opposite positions in the outer frame 40. The setting of the two magnets 32 can avoid the optical homogenizer 10′ from unnecessary swinging up and down at the end of the optical homogenizer as much as possible to affect uniform light effect.

In detail, the connecting mechanism 20 is used to connect the optical homogenizer 10′ and the outer frame to provide resilience for the optical homogenizer 10′ to vibrate back and forth.

In detail, the actuator 30′ is used to push the optical homogenizer 10′ along the direction of its optical axis OA cooperated with the connecting mechanism 20 to reciprocate and vibrate. In detail, reciprocating vibration along the optical axis OA is a movement with one degree of freedom, but the present disclosure is not limited thereto. In another embodiment, the de-speckle device may also be provided with a second or more sets of actuators and connecting mechanisms to provide movement with two or more degrees of freedom, for example, to move back and forth perpendicular to the axis of the optical homogenizer.

In detail, the optical homogenizer 10′ with a diffuse surface DS has the effect of diffusing the light beam entering the elongate structure to achieve preliminary speckle elimination, beam expansion, and light uniformity effects. By cooperating with the actuator 30′ to push the optical homogenizer 10′ to vibrate back and forth along the direction of its optical axis OA, the effect of speckle elimination can be enhanced.

In detail, depending on the type, size, and severity of the speckle, the vibration frequency of the actuator 30′ disclosed in the present disclosure is preferably greater than 0 Hz and less than 400 Hz, or a higher vibration frequency. The vibration displacement of the uniform light element 10 is preferably greater than 0 mm and less than 5 mm, or higher, to effectively eliminate speckles.

In one of the embodiments of the present disclosure, the four surfaces of the optical homogenizer 10′ of the de-speckle device 100″ include at least one reflecting surface RS or at least one diffuse surface DS. In detail, these surfaces can be selected from reflecting surface or diffuse surface and be combine according to actual needs.

In one embodiment of the present disclosure, the connecting mechanism 20 is an elastic element.

In one embodiment of the present disclosure, the elastic element is a plate spring.

In detail, in one of the embodiments disclosed herein, the plate spring is integrated with the elongate structure of the optical homogenizer 10′.

In one of the embodiments of the present disclosure, the diffuse surface of the optical homogenizer 10′ is formed with microstructures by means of nanoimprint, wafer-level lens, or metalens.

The vibration principle of the optical homogenizer 10′ of the de-speckle device 100″ is similar to that of FIGS. 6A and 6B, so it will not be repeated here. This reciprocating movement, or vibration, is a movement of one degree of freedom, but the disclosure is not limited thereto. In another embodiment, the de-speckle device can also be provided with a second or more sets of actuators and connecting mechanisms to provide movement in a second direction of a second degree of freedom, such as moving back and forth along a direction perpendicular to the axis of the optical homogenizer.

In detail, one end of the connecting mechanism 20 is fixed to the outer frame 40, and another end is fixed to the optical homogenizer 10′, wherein the outer frame 40 is a fixed part, and the optical homogenizer 10′ is a moving part. The connecting mechanism 20 can be used to position the optical homogenizer 10′ in the outer frame 40. In one of the embodiments of the present disclosure, the connecting mechanism 20 is a plate spring, and the plate spring can be a π-shaped plate structure, which can limit the optical homogenizer 10′ move in the direction parallel to the optical axis OA other than easy to move in other directions and affect the optical effect. The plate spring can also provide an elastic restoring force between the fixed part and the moving part, so that the optical homogenizer 10′ can vibrate back and forth under the push of the actuator 30′.

In one embodiment of the present disclosure, the magnet and the coil of the actuator 30′ can be interchanged correspondingly. The magnet and the coil are a set of actuators, which can drive the optical homogenizer 10′ to move through the electromagnetic force at a distance. Similarly, the magnets and coils are, for example, voice coil motors. The voice coil motor is used to make the diffuser vibrate at a small angle through a plate spring. The structure is simple, and the volume is smaller than the conventional motor-rotating wheel diffuser structure.

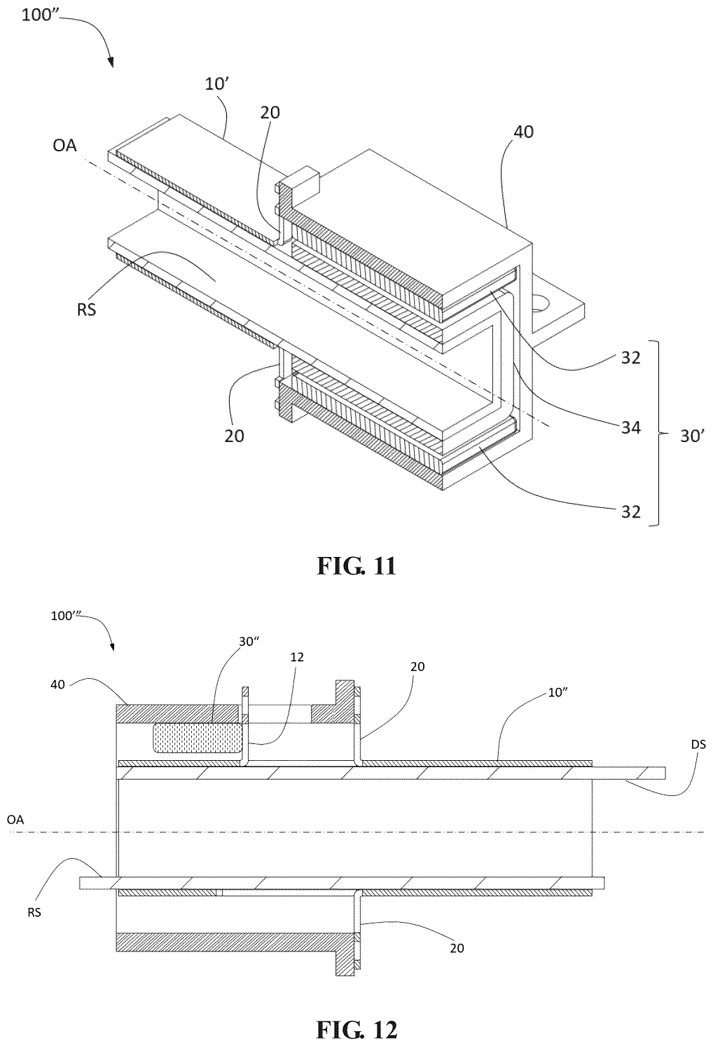

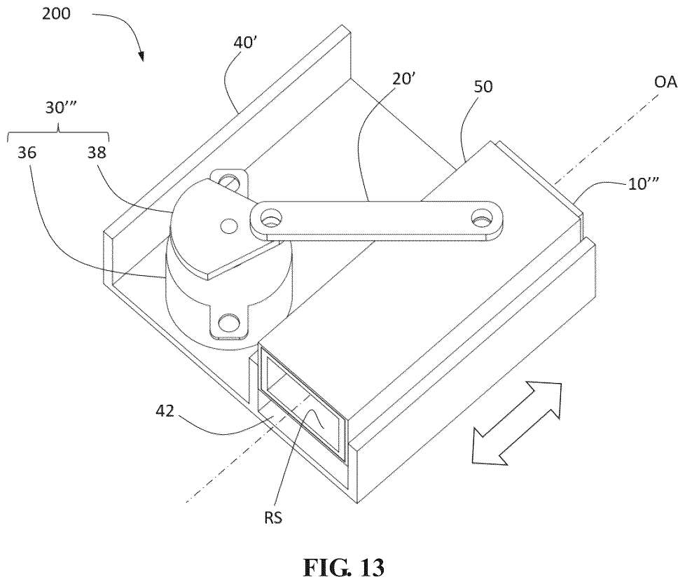

Referring to FIG. 12, in one of the embodiments of the present disclosure, unlike the aforementioned de-speckle device 100′ or 100″, the actuator 30″ of the de-speckle device 100′″ of this embodiment includes Piezoelectric element. In detail, the piezoelectric element can be arranged on the outer frame 40 and pushed against the protrusion 12 of the optical homogenizer 10″. A piezoelectric element is used to drive the optical homogenizer 10″ to move through a plate spring, and the structure is simple, and the volume is smaller than that of a conventional motor-rotating wheel diffuser structure.

In detail, the connecting mechanism 20 is used to connect the optical homogenizer 10″ to the outer frame 40, so as to provide a restoring force for the optical homogenizer 10″ to vibrate back and forth.

In detail, the actuator 30″ is used to push the optical homogenizer 10″ along the direction of its optical axis OA cooperated with the connecting part 20 to reciprocate and vibrate. In detail, reciprocating vibration along the optical axis OA is a movement with one degree of freedom, but the present disclosure is not limited thereto. In another embodiment, the de-speckle device may also be provided with a second or more sets of actuators and connecting parts to provide movement with two or more degrees of freedom, for example, to move back and forth perpendicular to the axis of the optical homogenizer.

In detail, the optical homogenizer 10″ with a diffuse surface DS diffuse the beam entering the elongate structure to achieve preliminary speckle elimination, beam expansion, and light uniform effects. By cooperating with the actuator 30″ to push the optical homogenizer 10″ to reciprocate and vibrate along the direction of its optical axis OA, the effect of speckle elimination can be enhanced.

In detail, depending on the type, size, and severity of speckles of the optical machine, the vibration frequency of the actuator 30″ disclosed herein is preferably greater than 0 Hz and less than 400 Hz, or a higher vibration frequency. The vibration displacement of the optical homogenizer 10″ is preferably greater than 0 mm and less than 5 mm, or a higher, so as to effectively eliminate speckles.

In one of the embodiments of the present disclosure, the four surfaces of the optical homogenizer 10″ of the de-speckle device 100′″ include at least one reflecting surface RS or at least one diffuse surface DS. In detail, these surfaces can be selected from reflecting surface or diffuse surface and be combined according to actual needs.

In one embodiment of the present disclosure, the connecting mechanism 20 is an elastic element.

In one embodiment of the present disclosure, the elastic element is a plate spring.

In detail, in one of the embodiments of the present disclosure, the plate spring is integrated with the elongate structure of the optical homogenizer 10″. The protrusion 12 of the optical homogenizer 10″ is also integrated with the elongate structure.

In one of the embodiments of the present disclosure, microstructures on substrate surface of the diffuser in the optical homogenizer 10″ is formed by nanoimprint, wafer-level lens, or metalens.

The vibration mode of the optical homogenizer 10″ of the de-speckle device 100′″ can refer to FIGS. 6A and 6B and will not be repeated here. The reciprocating movement, or vibration, is one degree of freedom movement, but the present disclosure is not limited thereto. In another embodiment, the de-speckle device can also be provided with a second or more sets of actuators and connecting mechanisms to provide movement in a second direction of a second degree of freedom, for example move back and forth perpendicular to the axis of the optical homogenizer.

The piezoelectric element in one of the embodiments of the present disclosure can be disposed on the optical homogenizer 10″ or on the outer frame 40, which is not limited by the present disclosure.

In detail, one end of the connecting mechanism 20 is fixed to the outer frame 40, and another end is fixed to the optical homogenizer 10″, wherein the outer frame 40 is a fixed part, and the optical homogenizer 10″ is a movable part. The connection mechanism 20 can be used to position the optical homogenizer 10″ in the outer frame 40. In one embodiment of the present disclosure, the connection mechanism 20 is a plate spring, and the plate spring can be in a π-shape. The plate-shaped structure can limit the movement of the optical homogenizer 10″ in the direction parallel to the optical axis OA other than easy movement in other directions and affect the optical effect. The plate spring can also provide an elastic restoring force between the fixed part and the movable part, so that the optical homogenizer 10″ can perform reciprocating vibration under the push of the actuator 30″.

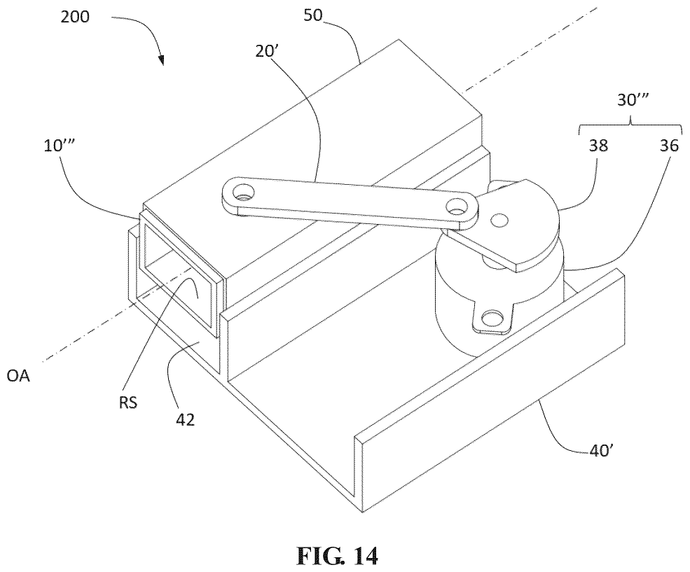

Referring to FIG. 13 and FIG. 14, in one embodiment of the present disclosure, different from the foregoing de-speckle devices 100, 100′, 100″, 100″, the actuator 30″ of the de-speckle device 200 of this embodiment includes a motor 36 and a cam 38, which drives the optical homogenizer 10′″ to reciprocate in a direction parallel to the optical axis OA through the connecting mechanism 20′.

In one of the embodiments of the present disclosure, the de-speckle device 200 further includes a bearing seat 50, and the optical homogenizer 10′″ is arranged on the bearing seat 50. In detail, the de-speckle device 200 further includes an outer frame 40′, the outer frame 40′ has a chute 42 parallel to the optical axis OA, and the bearing seat 50 is configured to slide in the chute 42. In detail, in an embodiment, the optical homogenizer 10″ similar to the optical homogenizer 10b in FIG. 4, is directly composed of four sheet structures and does not contain other mechanical components.

In detail, the actuator 30′″ of the de-speckle device 200 uses the motor 36 to rotate the cam 38 and drives the optical homogenizer 10′″ to slide in the chute 42 through the connecting mechanism 20′ to slide in parallel the direction of the optical axis OA to reciprocate.

The present disclosure can be applied to the architecture of lighting combination system in a laser projector or other systems using a laser light source. The display element may be a digital light processing element (DLP), a three-chips liquid crystal display element (3LCD), or a liquid crystal on silicon (LCOS). Because the speckle effect of the laser light source will cause spots of light to appear on the screen, the disclosure vibrates the optical homogenizer in the lighting system to achieve the effect of eliminating speckles.

Comparing with the prior art, by providing the actuator, the de-speckle device of the present disclosure can make the optical homogenizer move back and forth along its axial direction, which can simplify the structure, facilitate assembly, positioning, and adjustment of vibration path and direction of the component, and effectively avoid the problems in the prior art.

Although the disclosure has been shown and described with respect to one or more implementations, equivalent alterations and modifications will occur to those skilled in the art upon the reading and understanding of this specification and the annexed drawings. This disclosure includes all such modifications and variations and is limited only by the scope of the appended patent claims. In particular with respect to the various functions performed by the elements described above, terminology used to describe such elements is intended to correspond to any element (unless otherwise indicated) that performs the specified function of the element (e.g., which is functionally equivalent), even if there are no structural equivalents to the disclosed structures that perform the functions shown herein in the exemplary implementations of the specification. Furthermore, although a particular feature of this specification has been disclosed with respect to only one of several implementations, such a feature may be combined with one or more other features of other implementations that are desirable and advantageous for a given or particular application. Moreover, to the extent that the terms “comprises”, “has”, “comprising” or variations thereof are used in the detailed description or the claims, such terms are intended to be encompassed in a manner similar to the term “comprising”.

The above are only preferred embodiments of the present disclosure, and it should be pointed out that for those of ordinary skill in the art, without departing from the principle of the present disclosure, some improvements and modifications can also be made, and these improvements and modifications should also be regarded as protection scope of this disclosure.

What is claimed is:

1. A de-speckle device, comprising:
an optical homogenizer comprising a diffuse surface and a reflecting surface disposed opposite to the diffuse surface;
a connecting mechanism, wherein one end of the connecting mechanism is connected to the optical homogenizer; and
an actuator configured to move the optical homogenizer back and forth along an axis of the optical homogenizer.

2. The de-speckle device according to claim 1, wherein the de-speckle device further comprises a carrier, and the optical homogenizer is disposed on the carrier.

3. The de-speckle device according to claim 1, wherein the connecting mechanism is an elastic element.

4. The de-speckle device according to claim 1, wherein the diffuse surface comprises microstructures.

5. The de-speckle device according to claim 1, wherein the actuator is a piezoelectric element.

6. The de-speckle device according to claim 1, wherein the actuator comprises a motor and a cam and is configured to drive the optical homogenizer to move through the connecting mechanism.

7. The de-speckle device according to claim 1, wherein the actuator is provided with a first part and a second part corresponding to each other, wherein the first part and the second part are a magnet and a coil that are correspondingly interchangeable to drive the optical homogenizer to move through an electromagnetic force at a distance.

8. The de-speckle device according to claim 1, wherein the actuator is provided with a first part and a second part corresponding to each other, wherein the first part and the second part are a magnetic conductive element and an electromagnet that are correspondingly interchangeable to drive the optical homogenizer to move through an electromagnetic force at a distance.

9. The de-speckle device according to claim 1, wherein the actuator is configured to make the optical homogenizer move back and forth along a direction perpendicular to the axis of the optical homogenizer.

10. The de-speckle device according to claim 1, further comprising an outer frame, wherein the actuator comprises a magnet and a coil that are correspondingly interchangeable, one of the magnet and the coil is disposed on the uniform light element, and the other of the magnet and the coil is disposed at the outer frame corresponding the one of the magnet and the coil.

11. An optical homogenizer, comprising:
an elongate structure comprising a light incident end and a light outgoing end;
a diffuse surface facing an inner side of the elongated structure; and
a reflecting surface facing the inner side of the elongated structure and disposed opposite to the diffuse surface, wherein the optical homogenizer is configured to make a light beam entering through the light incident end exit from the light outgoing end.

12. The optical homogenizer according to claim 11, wherein the reflecting surface is a mirror surface.

13. The optical homogenizer according to claim 11, wherein the diffuse surface or the reflecting surface is disposed outside the elongate structure.

14. The optical homogenizer according to claim 11, wherein the light beam is at least reflected from the diffuse surface twice and from the reflecting surface twice before outgoing from the light outgoing end.

15. The optical homogenizer according to claim 11, wherein the optical homogenizer is a hollow integral rod or a solid integral rod.

16. The optical homogenizer according to claim 11, wherein microstructures are formed on the diffuse surface of the optical homogenizer by means of nanoimprint, wafer-level lens, or metalens.

17. A de-speckle device, comprising:
an optical homogenizer comprising a diffuse surface and a reflecting surface disposed opposite to the diffuse surface;
a connecting mechanism, wherein one end of the connecting mechanism is connected to the optical homogenizer;
an actuator configured to move the optical homogenizer back and forth along an axis of the optical homogenizer; and
an outer frame, wherein the optical homogenizer, the connecting mechanism, and the actuator are disposed on the outer frame.

18. The de-speckle device according to claim 17, wherein the outer frame comprises a chute and the optical homogenizer is configured to move back and forth in the chute.

19. The de-speckle device according to claim 17, further comprising a carrier, and the optical homogenizer is disposed in the carrier.

20. The de-speckle device according to claim 17, wherein the actuator comprises a motor and a cam and is configured to drive the optical homogenizer to move through the connecting mechanism.
